(19) United States
(12) Patent Application Publication
(10) Pub. No.: US 2019/0392733 A1
(43) Pub. Date: Dec. 26, 2019

(54) Method for Measuring Sign Recognition Ability in Learners of American Sign Language (ASL) as a Second Language

(71) Applicants: Joseph Bochner, Victor, NY (US); Wayne M. Garrison, Baltimore, MD (US); Vincent J. Samar, Rochester, NY (US)

(72) Inventors: Joseph Bochner, Victor, NY (US); Wayne M. Garrison, Baltimore, MD (US); Vincent J. Samar, Rochester, NY (US)

(73) Assignee: Rochester Institute of Technology, Rochester, NY (US)

(21) Appl. No.: 16/019,074

(22) Filed: Jun. 26, 2018

(51) Int. Cl. G09B 21/00; G09B 7/06

(52) U.S. Cl. CPC G09B 21/009; G09B 7/06

(57) ABSTRACT

A method for measuring sign (lexical) recognition ability in American Sign Language (ASL) embodies an adaptive sign recognition test that includes a calibrated item pool, each item having a difficulty value (dᵢ) and associated standard error (sₑ). Test items are administered to a group of individuals spanning a wide range of ASL abilities to obtain responses. The responses are subjected to Rasch scaling analysis. The adaptive sign recognition test can be administered to an individual to determine their level of ability in ASL.

### FIELD

This invention provides a method for determining sign recognition ability in American Sign Language (ASL).

### BACKGROUND

To date, sign recognition ability has not been used to evaluate second language learners' ability in ASL.

The level of an individual's ASL ability generally has been quantified in terms of their ability to produce acceptable signed utterances.

In practice, ASL ability is usually determined via an interview procedure administered by a fluent ASL signer following a well-defined interview protocol and a team of trained raters who also are fluent signers evaluate the test-taker's performance following a well-defined scoring rubric, as occurs with the Sign Language Proficiency Interview (SLPI) and the American Sign Language Proficiency Interview (ASLPI).

### SUMMARY

In accordance with one aspect of the present invention, a method is provided for determining sign recognition ability in adult learners of ASL as a second language, including developing an adaptive sign recognition test including a plurality of items, each item containing two pairs of signed utterances; by administering items from the plurality of items of the adaptive sign recognition test to a first group of individuals across a wide range of ASL ability levels to obtain a response to the items; subjecting the responses to a scaling analysis to assign a difficulty value (dᵢ) and associated standard error (sₑ) to the items to create a calibrated item pool; administering items from the calibrated item pool to a second group of individuals having varying levels of ASL ability to obtain a response to the calibrated items; calculating a test score for each individual based upon the responses to the calibrated items.

In accordance with another aspect of the present invention, there is provided a method for measuring sign recognition ability comprising: administering an adaptive sign recognition test to an individual, which comprises administering to the individual a plurality of items from a calibrated item pool comprising items scaled along a continuum of sign recognition difficulty, each item comprising two trials and each trial comprising paired signed utterances, wherein the paired signed utterances can be the same or different from one another and the difference comprises linguistic contrasts occurring within minimal pairs, obtaining a response from the individual based on the individual's ability to distinguish the linguistic contrasts by a comparison of a first signed utterance of the paired signed utterances with a second signed utterance of the paired signed utterances, wherein the relative difficulty of a subsequent item is determined by the correctness of the response to a previous item; assigning a scoring value to the response from the individual for each administered item; and obtaining a test score for the individual based upon the responses to the administered items.

In accordance with another aspect of the present invention, there is provided a method for measuring sign recognition ability comprising: developing an adaptive sign recognition test by administering to a first group of individuals having a broad range of ASL abilities items from a plurality of items, wherein each item comprises two trials and each trial comprises paired signed utterances; obtaining responses from the first group of individuals based on their ability to distinguish linguistic contrasts by a comparison of a first signed utterance of the paired signed utterances with a second signed utterance of the paired signed utterances, wherein the paired signed utterances can be the same or different from one another and the difference comprises linguistic contrasts occurring within minimal pairs; subjecting the responses to a scaling analysis to assign a difficulty value (dᵢ) and associated standard error (sₑ) to the items to create a calibrated item pool comprising items scaled along a continuum of sign recognition difficulty; administering the developed adaptive sign recognition test to a second group of individuals, comprising one or more individuals, by administering a plurality of the items from the calibrated item pool to the second group of individuals; obtaining a response to the administered calibrated items from the second group of individuals based on their ability to distinguish the linguistic contrasts by a comparison of a first signed utterance of the paired signed utterances with a second signed utterance of the paired signed utterances, wherein the relative difficulty of a subsequent item is determined by the correctness of the response to a previous item; and calculating a test score for individuals in the second group based upon the responses to the administered items.

### BRIEF DESCRIPTION OF THE DRAWINGS

The present invention will be more fully understood and appreciated by reading the following Detailed Description in conjunction with the accompanying drawing, in which:

FIG. 1 depicts a flowchart illustrating the operation of a portion of the ASL-DT adaptive testing system; and

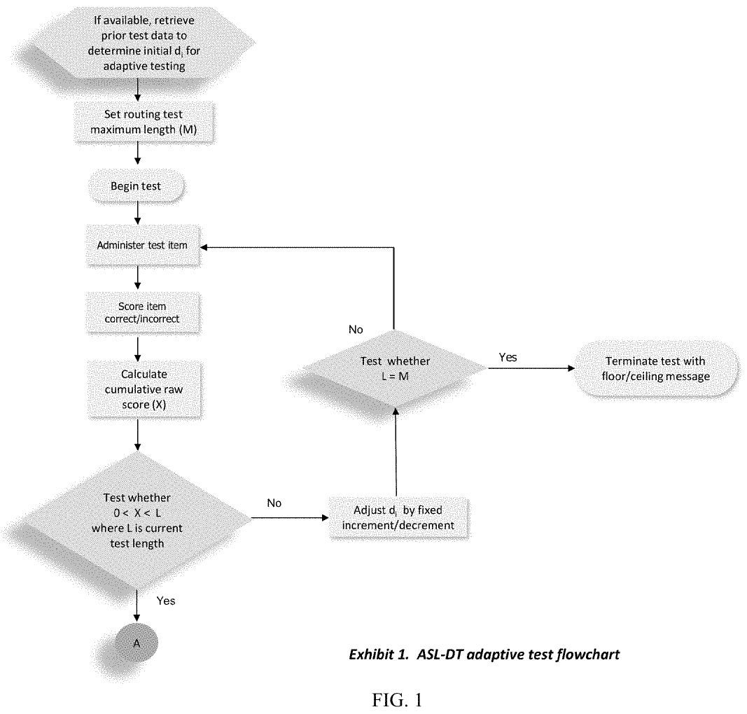

FIG. 2 depicts a flowchart illustrating a continuation of the operation of the ASL-DT adaptive testing system shown in FIG. 1.

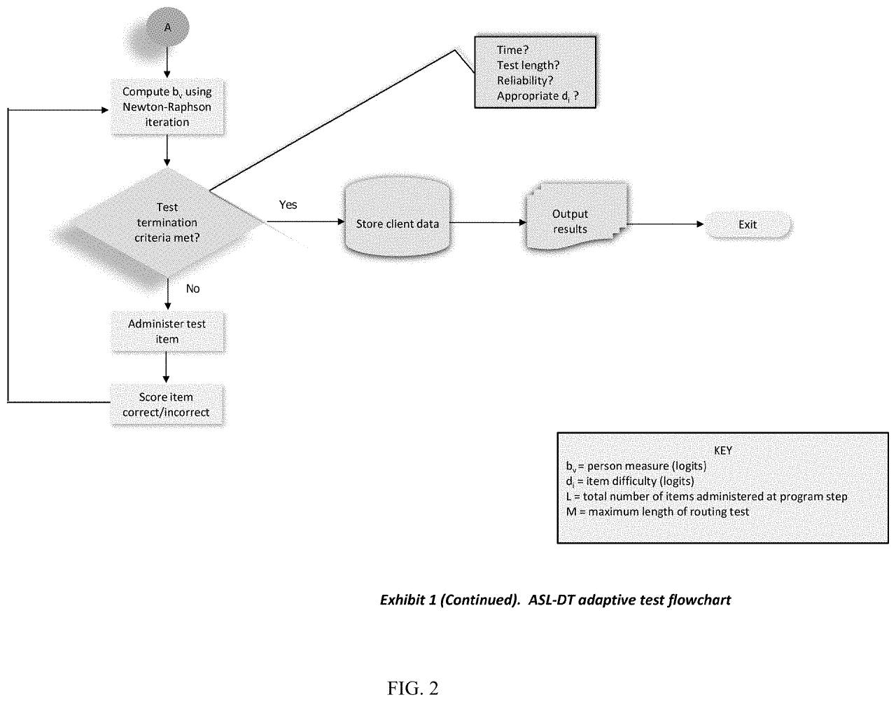

### DETAILED DESCRIPTION

This invention provides a method for determining sign recognition ability in ASL. An embodiment of the method includes an adaptive sign recognition test. The adaptive sign recognition test can be administered to an individual to determine their overall level of ASL ability. A suitable adaptive sign recognition test includes a plurality of items. In an embodiment, each item can include two trials and each trial can include two signed utterances, e.g., a standard utterance followed by a comparison utterance. Other numbers of trials and utterances are suitable for use in the method. The comparison utterance can be the same or different from the standard utterance in each trial. The plurality of items may be referred to herein as the pool of items or item pool. A suitable adaptive sign recognition test can be developed by administering items from the item pool to a first group of individuals having a wide range of ASL abilities to obtain their responses. In an embodiment, each one of the items in the item pool is administered to each member of the first group of individuals to obtain their responses to each item. An item is scored correct if and only if the response to both trials is correct. The responses to the items from the first group of individuals are subjected to a scaling analysis to assign a difficulty value (dᵢ) and associated standard error (sₑ) to each item, thereby creating a calibrated item pool. The calibrated item pool can be used for adaptive sign recognition testing of a second group of individuals. The second group of individuals can be the same or different than the first group of individuals. Items from the calibrated item pool are administered to the second group of individuals to obtain their responses. In an embodiment, a subset of the items in the calibrated item pool is administered to each member of the second group of individuals using the adaptive test to obtain their responses to each item. An item is scored correct if and only if the response to both trials is correct. The responses to each item are used to calculate a test score for each individual. The adaptive sign recognition test now can be administered to an individual to obtain a test score. The test score then can be interpreted as a measure of ASL ability.

The adaptive sign recognition test can be delivered by methods known in the art, such as via a computer-interactive assessment system. The test can be administered, for example, by a software application to efficiently provide meaningful information about the sign recognition abilities and ASL proficiency of learners across a wide range of ability levels in ASL.

An embodiment for developing suitable items for use in the present method includes stimulus materials composed of utterances that include linguistic contrasts (primarily minimal pairs). Preferably, naturalistic sentence-length utterances are used; however utterances composed of single words, phrases or more than one sentence also can be used. The linguistic contrasts contained in the utterances involve phonological and morphophonological features of ASL such as orientation, handshape, location, movement and complex morphology. Preferably, the test contains linguistic contrasts distributed over five broad linguistic categories: 1) orientation; 2) handshape; 3) location; 4); movement and 5) complex morphology. A sample item from each category is included below for illustrative purposes.
Orientation: WE SUSPENDED/GOOD-FRIEND HARD TO BELIEVE
   “It is hard to believe that we're suspended!”
   “It is hard to believe that we're good friends!”
Handshape: POTATOES/TIMING GOOD
   “The potatoes are good”
   “The timing is good”
Location WOW YOU SMART/LUCKY
   “Wow, you are smart.”
   “Wow, you are lucky.”
Movement MAN-IX (POINTING) HIKING/MAN-IX AWKWARD
   “That man is hiking.” or “The man is hiking.”
   “That man is awkward.” or “The man is awkward.”
Complex Morphology NORMAL AGE LEARN+++ LANGUAGE WHEN (rhq) AROUND TWO-YEARS-OLD/THREE-YEARS-OLD
   “The normal age to acquire language is approximately 2 years old”
   “The normal age to acquire language is approximately three years old.”
   MY DOG-HAIR THICK (CL:C)/THIN (CL:G)
   “My dog's hair is thick.”
   “My dog's hair is thin.”

The Complex Morphology category includes morphophonological contrasts in number incorporation, directional verbs, noun classifier usage, and verb inflection.

A sixth category of items representing repetitions of the standard sentence also is included in the item pool. This category does not contain any contrastive linguistic elements. Both comparison sentences are repetitions of the standard sentence and, as such, the correct response to each trial for items in this category is ‘Same.’ Preferably, about 10% of the item pool is composed of items in this category.

Preferably, the utterances are produced by three different signers. The utterances also may be produced in varying social or regional dialects of ASL either separately or in combination with the standard dialect.

In accordance with an embodiment, the utterances are recorded, preferably digitally, and edited to develop a set of video files. Each video file is composed of one utterance. The utterances (video files) are used to construct the test items. The stimuli are digitally recorded. Multiple renditions/tokens of each utterance are recorded, and a good quality, representative token is selected for inclusion in the test.

Each of the recorded materials (test items) is administered to a sample of individuals spanning a range of ASL abilities. Each test item is presented to each respondent using a paired comparison discrimination task. For example, a common-item test composed of at least 250 items may be administered to a sample of at least 30 respondents. Preferably, a common-item test composed of approximately at least 300 items is administered to a sample of at least 100 respondents. However, other size groups and number of test items are suitable for use in the present method.

Although it is possible to design and administer computerized adaptive tests without item response theory (IRT), IRT-based systems have advantages over those that are not IRT-based and thus are preferred. Chief among these advantages is placement of the item difficulty (dᵢ) and person ability (bᵥ) estimates on the same numerical scale in IRT, facilitating the selection of items of appropriate difficulty for an individual. IRT scoring procedures also make it possible to estimate a respondent's ability level and the associated standard error or precision immediately following the administration of each test item, the former statistic aiding in item selection, the latter being useful for terminating a testing session.

IRT models are mathematical abstractions based upon suppositions about what happens when an examinee responds to a test item. The simplest of the IRT models, also the basis of the current test method, is the Rasch (1960) one-parameter logistic model. Item difficulty is an intrinsic parameter of item response theory models, with variations in item difficulty being necessary for the creation of item pools used in adaptive testing. The Rasch model differs significantly from more complicated models in that it is not intended to fit data. Rather, the Rasch model is a definition of measurement. When data are found to fit the model, the measurement of persons and the assignment of difficulty values to items (i.e., calibration of items) enable the placement of persons and items on a common scale that functions according to the rules of arithmetic. This scale uses a logarithmic unit of measurement known as the logit. The logit metric applies to both items and test takers. That is, the logit is a measure of both item difficulty and person ability.

Data obtained from administration of the common-item tests administered to respondents are subjected to Rasch scaling analysis to develop the calibrated item pool. This analysis assigns a difficulty value (dᵢ) and associated standard error (sₑ) to each item of the test. The difficulty value and standard error associated with each item enable the items to be scaled along a continuum of difficulty, providing the basis for the “up-down” psychophysical method of item selection used in adaptive testing.

The Rasch model for person measurement conceptualizes success or failure on any test item as a function of the difference between an examinee's position on an ability continuum and the difficulty of items scaled along the same continuum. The way that this difference governs the outcome of the person—item interaction is then modeled probabilistically.

In its simplest form, the Rasch model can be presented as follows:

Probability {x_{νι}=1}=exp(β_{ν}−δ_{ι})/[1+exp(β_{ν}−δ_{ι})]

where x_{νι}=1 if person ν responds correctly to item ι;

β_{ν}=a parameter describing the ability of person ν; and

δ_{ι}=a parameter describing the difficulty of item ι.

In the above formulation, β and δ can assume all real values and measure ability and difficulty respectively on the logit scale which they share. The sign of the difference between the two parameters in any particular instance indicates the probable outcome of the person—item interaction. If β_{ν}>δ_{ι} the most probable outcome is a correct response to a test item. If β_{ν}<δ_{ι} then the most probable outcome is an incorrect response.

The logistical distribution is one of two statistical distributions which have been used to model the probabilistic aspect of testing outcomes in the field of psychometrics, as well as in many other scientific and biometric applications (e.g., growth and mortality rates). The Rasch model is based upon the logistic distribution. The β_{ν} and δ_{ι} that appear in the formulation above represent parameters. In practice, these parameters are estimated from observed data. The statistic estimating β_{ν} is bᵥ, while the statistic estimating δ_{ι} is dᵢ.

From the foregoing discussion, the probability associated with a successful outcome on any particular person—item interaction is determined. The probability is an exponential function of the difference between bᵥ and dᵢ. The bᵥ estimate is obtained from an individual's testing experience. The dᵢ values will have been obtained from previous test results. There is one bᵥ value for each person tested, and one dᵢ value for each item that exists within an item pool. When a respondent completes a test session, their score provides an estimate of their level of ability based upon the difficulty values of the items presented during the test session.

The responses of persons to the individual items constitute the raw data from which the item calibrations (dᵢ) and person measures (bᵥ) are obtained. In the usual scaling analysis, raw data are organized in matrix form. Persons appear as rows, items appear as columns. The data entries are 1's and 0's, where ‘1’ represents a correct response of an individual to an item, ‘0’ represents an incorrect response. Person scores are initially obtained by summing the 1's and 0's across items for each person tested. Item scores are initially obtained by summing the 1's and 0's across persons for each item in the test. These marginal sums are sufficient for estimating the dᵢ and bᵥ statistics. Preferably, a calibrated item pool composed of approximately 300 items is established with associated dᵢ values.

In an embodiment, the adaptive sign recognition test is composed of utterances containing linguistic contrasts, primarily minimal pairs. The test uses a paired comparison discrimination task in which a standard is paired with a comparison utterance. Respondents must decide if the standard and comparison stimuli in each trial are the same or different from each other. The presentation of an item begins with the presentation of two utterances displayed in succession on the monitor. Each respondent indicates if the two utterances are the same or different from one another. Then, a second pair of utterances is presented, and the respondent must indicate if the utterances are the same or different from one another. An item is scored correct when the participant responds correctly to both utterance pairs. No partial credit is awarded. All responses are recorded, preferably on a computer hard drive.

Respondents are instructed to compare the standard and comparison stimuli and indicate if they match (i.e., if the stimuli have the same meaning). They are informed that any combination of ‘Same’ and ‘Different’ trials is possible, allowing for four potential response outcomes: S-D, D-S, D-D, and S-S. The test session begins after respondents demonstrate that they understand the task by successfully completing a set of 5-15 practice items. Sample test items are presented in Paragraph [0013] above.

Examinees indicate whether the stimuli presented in each trial are the ‘same’ or ‘different.’ This can be done in any manner, such as by pressing a button on a response box, clicking a computer mouse or pressing a touch screen.

The Rasch model is used to quantify the difficulty of test items scaled along the continuum extending from low to high degrees of sign recognition ability. The model enables the discovery of this continuum and the scaling of item difficulty. The continuum of item difficulty, in turn, provides an implicit hierarchy that enables the adaptive testing procedure to utilize an “up-down” method of item selection to array respondents on the same continuum as the items. The continuum of item difficulty generally reflects the test-taker's ability to perceive signs. The pool of items in the test preferably includes at least 250 items and more preferably includes about 300 unique utterance pairs (items).

Since the test is suitable for being administered by a software application, it may be delivered over the internet and/or self-administered by test takers. Preferably, the software will be an internet-based application. Alternately, the software may be a desktop application.

The adaptive sign recognition test of the present invention differs from conventional tests in that the testing experience is individualized and automated, with items being selected “on the fly” from a large pool by an objective “up—down” method on the basis of their information value. The “up—down” method of item selection is designed such that the items administered to each person are selected from a relatively narrow range of difficulty circumscribing their level of ability, which is itself constantly updated as items are administered during the testing process. The standard error associated with the respondent's performance is used to limit the range of difficulty from which items are selected for presentation within each test session. In limiting the range of difficulty from which items are selected, the up-down procedure greatly reduces measurement error in comparison to conventional word recognition tests. Importantly, the adaptive item selection procedure enhances measurement precision for individuals in comparison to conventional word recognition tests because of the systematic manner in which the up-down psychophysical method brackets the respondent's sign recognition ability level within progressively smaller ranges of measurement error. The standard error (sₑ) determines the step size for the up-down procedure and can be set at values of ±1.0, ±1.5 or ±2.0 sₑ depending upon the psychometric properties of the item pool and the level of measurement precision desired. Preferably, a setting of ±1.5 sₑ is used as the default value.

Scores on the test have been shown to be highly reliable, having an internal consistency reliability of 0.83, as determined by the person separation reliability index commonly used in Rasch scaling analysis. Prespecification of the level of measurement accuracy or reliability required of respondents is built into the functionality of the adaptive testing software. In practice, there is a trade-off between the accuracy of test results and test administration time. As more test items are administered to a respondent, the accuracy (reliability) of the test score increases and so does the test administration time. Therefore, in practice, examiners can determine an appropriate balance between the accuracy of test results and test administration time.

Preferably, the test uses a maximum length of 40 items and a maximum duration of 20 minutes. Also, reliability values can be changed to different settings (e.g., 0.75, 0.80, 0.85 or 0.90), as can standard error of measurement (±1.0, ±1.5 or ±2.0), in an effort to achieve specific degrees of measurement precision. Preferably, the test uses 0.90 as the default setting for reliability and ±1.5 as the default setting for standard error. These values have proven practical and useful within the context of the present invention.

The test operates using a pre-calibrated item pool in a system with three main components: (1) an item selection routine; (2) an ability estimation technique; and (3) one or more rules for test termination. For example, a preferred embodiment includes approximately 300 pairs of utterances in the test item pool. An item is composed of one standard and two comparison stimuli as described above. Through differing permutations and combinations of standard/comparison stimuli within the item pool, the 300 pairs of utterances (test items) can be increased to more than 3,000 test items. Associated with each item is a dᵢ value characterizing its location (magnitude) on the variable that is measured by the test (i.e., sign recognition ability). The dᵢ values, expressed in logits or log units, are generally referred to as item calibrations or difficulty measures.

The test can be self-administered, for example, on a home computer, on a wireless device, in a kiosk setting or in a classroom/educational environment. The stimuli are presented to respondents on a computer monitor. Examinees indicate whether the comparison sentences are the ‘same’ or ‘different’ via computer mouse. If no response is produced within a preset response interval, the trial is scored incorrect. Items are scored correct when both discrimination judgments (i.e., both trials) are correct. This scoring practice is designed to decrease the influence of random guessing in the ability estimation procedure. Testing can begin with several practice items.

The application can use preexisting data (e.g., respondent self-perception of ASL ability) to determine the difficulty (dᵢ) of the first test item to be administered to an individual. Specifically, the first item is empirically related to one or more of the following variables: (1) prior performance on the test and (2) the respondent's self-perception of their ASL ability. These data can be used to guide the test application where testing is to begin by predicting a point on the continuum of item difficulty proximal to the respondent's level of ability. This enhances the efficiency and accuracy of measurement.

The test procedure preferably is composed of two stages. The first stage of testing, the routing test, proceeds until an individual responds correctly and incorrectly to the items presented. To illustrate, the first item administered has, for example, dᵢ=0.25 logit. If the examinee responds correctly (incorrectly), an item of greater (lesser) difficulty is administered next. The increment (decrement), here 0.50 logit, remains fixed and constant at this stage of testing. Thus, the second item to be administered will be that item in the pool having difficulty closest to +0.75 or −0.75 logit depending on the response to the previous item. The fixed increment (decrement) is continued until at least one correct and one incorrect response have been observed. The magnitude of the fixed increment may be varied depending upon the psychometric characteristics of the item pool.

It will be the case that some individuals tested may be outside the ability limits to which the test is sensitive. Thus, for individuals for whom both correct and incorrect responses have not been observed upon reaching the extremities of difficulty or easiness, testing terminates with a message indicating that these individuals have sign recognition ability levels which are indeterminate. The maximum length of the routing test (M) is set at the onset of testing (e.g., the maximum length may range from or 7-14 items). Preferably, the maximum length of the routing test (M) is set to M=10 items.

When at least one correct and one incorrect response to the test items have been observed for an individual, a finite maximum likelihood estimate of ability (bᵥ), as well as its associated standard error sₑ, can be computed. This occurs in the second stage of testing. The numerical estimation method employed here possesses the property that an individual's number right or raw score is a sufficient statistic for estimation of the ability parameter.

Using the estimate of ability bᵥ computed in the previous programming step, test items in the pool that have not already been administered are evaluated for their potential to provide additional information about the examinee. Specifically, the next item to be administered will be that item which has dᵢ closest to bᵥ, with the further condition that the difference between the ability estimate and the selected item's difficulty must be less than the standard error associated with the ability estimate. If these two conditions cannot be met, the testing is terminated with a message that test items of appropriate difficulty have been exhausted. After each newly selected test item is presented and the examinee's response is evaluated for correctness/incorrectness, the bᵥ is revised, making use of the additional information. The revised bᵥ is compared, as earlier, with the dᵢ of items remaining in the pool that have not already been administered. In this way, test items continue to be administered to an examinee as long as the difference between the item difficulty and each newly computed bᵥ remains within a decreasing standard error of measurement.

Testing is terminated when: (1) items remaining in the pool are of inappropriate difficulty; (2) an individual has responded to L items; (3) the testing session reaches a predetermined time limit; or (4) an individual has been tested to a predetermined level of precision or reliability. Each of these test termination criteria is set in advance by the examiner, preferably based on factors such as practicality and usefulness. Experience demonstrates that it is practical and useful to terminate testing after 20 minutes or 40 items, whichever occurs first in the testing session, or after a reliability of 0.90 has been attained. At the conclusion of the assessment procedure, the test data are stored and optional reports output.

A suitable adaptive sign recognition test in accordance with the present invention includes a computer-interactive assessment system developed at the National Technical Institute for the Deaf (NTID) known as the American Sign Language Discrimination Test (ASL-DT).

ASL-DT is a computerized adaptive sign recognition test administered by a software application that uses naturalistic sentence-length utterances to efficiently provide meaningful information about the ASL abilities of learners across a wide range of ability levels. Test items are presented to respondents using a paired comparison discrimination task.

A common-item test composed of about 50 items was initially administered to a sample of respondents (Sample A). The item pool was subsequently expanded by administering about 250 additional items to another sample of respondents (Sample B).

The relative difficulties (dᵢ values) of the nearly 300 items in the item pool were computed by subjecting to Rasch scaling analysis the data obtained from administration of the common-item tests to Samples A and B as described above. The responses of persons to the individual items constituted the raw data from which the item calibrations (dᵢ) and person measures (bᵥ) were obtained. In the scaling analysis, the raw data were organized in matrix form with persons appearing as rows and items appearing as columns. The data entries were 1's and 0's, where ‘1’ represents a correct response of an individual to an item, ‘0’ represents an incorrect response. Person scores are initially obtained by summing the 1's and 0's across items for each person tested. Item scores are initially obtained by summing the 1's and 0's across persons for each item in the test. These marginal sums are sufficient for estimating the dᵢ and bᵥ statistics. A calibrated item pool composed of approximately 300 items with associated dᵢ values was developed in this way.

The ASL-DT is composed of sentence-length utterances containing phonetic contrasts, primarily minimal pairs. Respondents must decide if the two sentences comprising each trial are the same or different from each other. The test includes items containing linguistic contrasts in the ASL features of movement, handshape, location, orientation, and complex morphology. The ASL-DT contains linguistic contrasts distributed over five broad linguistic categories: 1) movement; 2) handshape; 3) location; 4) orientation; and 5) complex morphology.

A sixth category of items representing repetitions of the standard sentence was also included in the item pool. This category did not contain any contrastive linguistic elements. Both comparison sentences are repetitions of the standard sentence and, as such, the correct response to each trial for items in this category is the ‘Same.’ About 10% of the item pool is composed of items in the ‘Same’ category.

As described above, the ASL-DT uses a paired comparison discrimination task in which a standard sentence is paired with two comparison sentences. An item is scored correct if and only if the participant responds correctly to both comparison sentences. No partial credit is awarded. Therefore, if the response to the first trial is incorrect, the item is scored incorrect. All responses were recorded on a computer hard drive.

Respondents are instructed to compare the standard and comparison sentences and indicate if the two sentences match (i.e., if the sentences have the same meaning). They are informed that any combination of ‘Same’ and ‘Different’ trials is possible, allowing for four potential response outcomes: S-D, D-S, D-D, and S-S. The test session begins after respondents demonstrate that they understand the task by successfully completing a set of 10 practice items. Examinees indicate whether the sentences presented in each trial are the ‘same’ or ‘different,’ by pressing a button on a response box, clicking a computer mouse or pressing a touch screen.

The ASL-DT sign recognition testing experience is individualized, with items being selected “on the fly” from a large pool by an objective “up—down” method on the basis of the item information value. The items administered to each person are selected from a narrow range of difficulty spanning an individual's level of ability, which is itself constantly updated as items were administered during the testing process. The plurality of test items comprising the item pool includes about 300 unique sentence pairs.

Scores on the ASL-DT have been shown to be highly reliable, having an internal consistency reliability of 0.83, as determined by the person separation reliability index commonly used in Rasch scaling analysis. Prespecification of the level of measurement accuracy or reliability required of respondents is built into the functionality of the adaptive testing software. As more test items are administered to a respondent, the accuracy (reliability) of the test score increases and so does the test administration time. Therefore, in practice, examiners need to determine an appropriate and desirable balance between the accuracy of test results and test administration time.

The adaptive test length, defined in terms of the number of items was set at 40 items and the time of test duration was set at 20 minutes. ASL-DT uses 0.90 as the default setting for reliability and ±1.5 as the default setting for standard error.

The ASL-DT operates using a pre-calibrated item pool in a system with three main components: (1) an item selection routine; (2) an ability estimation technique; and (3) one or more rules for test termination. The ASL-DT can be self-administered on a home computer or wireless device, in a kiosk setting or in a clinical environment. Examinees indicate whether the comparison sentences are the ‘same’ or ‘different’ via computer mouse or touch screen. If no response is produced within a preset response interval, the trial is scored incorrect. Items are scored correct if and only if both discrimination judgments (i.e., both trials) are correct. Testing begins with several practice items.

ASL-DT differs from conventional tests in that the testing experience is individualized and automated, with items being selected by an objective “up—down” method on the basis of their information value. The items are scaled along a continuum extending from low to high degrees of sign recognition difficulty, and the continuum of item difficulty generally reflects the respondent's ability to perceive phonological and morphophonological properties of sign, such as orientation, location, handshape, movement and complex morphology. Since the test is administered by a software application, it may be delivered over the internet and/or self-administered by test takers. Importantly, the adaptive item selection procedure enhances measurement precision for individuals in comparison to conventional tests because of the systematic manner in which the up-down psychophysical method brackets the respondent's sign recognition ability level within progressively smaller ranges of measurement error. The standard error (sₑ) determines the step size for the up-down procedure, and the ASL-DT uses a setting of ±1.5 sₑ as the default value.

The Figure illustrates a flowchart of the operation of the ASL-DT adaptive testing system. The application uses preexisting data to determine the difficulty (dᵢ) of the first test item to be administered to an examinee to enhance the efficiency and accuracy of measurement. Specifically, the first item is empirically related to either or both of the following variables: (1) prior performance on the ASL-DT and/or (2) the respondent's self-perception of their ASL ability.

The ASL-DT test procedure is composed of two stages. The first stage of ASL-DT testing, the routing test, proceeds until an examinee responds correctly and incorrectly to the items presented. To illustrate, the first item administered has, for example, dᵢ=0.25 logit. If the examinee responds correctly (incorrectly), an item of greater (lesser) difficulty is administered next. The increment (decrement), here 0.50 logit, remains fixed and constant at this stage of testing. Thus, the second item to be administered will be that item in the pool having difficulty closest to +0.75 or −0.75 logit depending on the response to the previous item. The fixed increment (decrement) is continued until at least one correct and one incorrect response have been observed.

It will be the case that some individuals tested may be outside the ability limits to which the ASL-DT is sensitive. Thus, for individuals for whom both correct and incorrect responses have not been observed upon reaching the extremities of difficulty or easiness, ASL-DT testing terminates with a message indicating that these individuals have sign recognition ability levels which are indeterminate. The maximum length of the routing test (M) was set at M=10 items at the onset of testing.

When at least one correct and one incorrect response to the ASL-DT items have been observed for an individual, a finite maximum likelihood estimate of ability (bᵥ), as well as its associated standard error sₑ, is computed. This occurs in the second stage of testing. The numerical estimation method employed here possesses the property that an individual's number right or raw score is a sufficient statistic for estimation of the ability parameter.

Using the estimate of ability bᵥ computed in the previous programming step, test items in the ASL-DT pool that have not already been administered are evaluated for their potential to provide additional information about the examinee. Specifically, the next item to be administered will be that item which has dᵢ closest to bᵥ, with the further condition that the difference between the ability estimate and the selected item's difficulty must be less than the standard error associated with the ability estimate. Otherwise, testing is terminated with a message that ASL-DT items of appropriate difficulty have been exhausted.

After each newly selected test item is presented and the examinee's response is evaluated for correctness/incorrectness, the bᵥ is revised, making use of the additional information. The revised bᵥ is compared, as earlier, with the dᵢ of items remaining in the pool that have not already been administered. In this way, ASL-DT items continue to be administered to an examinee as long as the difference between the item difficulty and each newly computed bᵥ remains within a decreasing standard error of measurement.

Testing is terminated when: (1) items remaining in the pool are of inappropriate difficulty; (2) an individual has responded to L items; (3) the testing session reaches a predetermined time limit; or (4) an individual has been tested to a predetermined level of precision or reliability. Each of these test termination criteria is set in advance by the examiner. For the ASL-DT, testing is terminated after five minutes or 40 items, whichever occurs first in the testing session, or after a reliability of 0.90 has been attained. At the conclusion of the assessment procedure, the ASL-DT test data are stored and optional reports output.

What is claimed is:

1. A method for measuring sign recognition ability comprising:
administering an adaptive sign recognition test to an individual, which comprises administering to the individual a plurality of items from a calibrated item pool comprising items scaled along a continuum of sign recognition difficulty, each item comprising two trials and each trial comprising paired signed utterances, wherein the paired signed utterances can be the same or different from one another and the difference comprises linguistic contrasts occurring within minimal pairs, obtaining a response from the individual based on the individual's ability to distinguish the linguistic contrasts by a comparison of a first signed utterance of the paired signed utterances with a second signed utterance of the paired signed utterances, wherein the relative difficulty of a subsequent item is determined by the correctness of the response to a previous item;
assigning a scoring value to the response from the individual for each administered item; and
obtaining a test score for the individual based upon the responses to the administered items.

2. A method for measuring sign recognition ability comprising:
developing an adaptive sign recognition test by administering to a first group of individuals having a broad range of ASL abilities items from a plurality of items, wherein each item comprises two trials and each trial comprises paired signed utterances;
obtaining a response from the first group of individuals based on their ability to distinguish linguistic contrasts by a comparison of a first signed utterance of the paired signed utterances with a second signed utterance of the paired signed utterances, wherein the paired signed utterances can be the same or different from one another and the difference comprises linguistic contrasts occurring within minimal pairs;
subjecting the responses to a scaling analysis to assign a difficulty value (dᵢ) and associated standard error (sₑ) to the items to create a calibrated item pool comprising items scaled along a continuum of sign recognition difficulty;
administering the developed adaptive sign recognition test to a second group of individuals by administering a plurality of the items from the calibrated item pool to the second group of individuals;
obtaining a response to the administered calibrated items from the second group of individuals based on their ability to distinguish the linguistic contrasts by a comparison of a first signed utterance of the paired signed utterances with a second signed utterance of the paired signed utterances, wherein the relative difficulty of a subsequent item is determined by the correctness of the response to a previous item; and
calculating a test score for the individuals in the second group based upon the responses to the administered items.

3. The method of claim 2, wherein the adaptive sign recognition test initially proceeds until an individual from the second group of individuals correctly responds to one item and incorrectly to another of the items presented; if the individual responds correctly, an item of greater difficulty is administered next, if the individual responds incorrectly, an item of lesser difficulty is administered next; the increment or decrement remains fixed and constant at this stage of testing; the second item to be administered will be that item in the plurality of items comprising the item pool having difficulty closest to the adjacent logit; and the fixed increment or decrement is continued until at least one correct and one incorrect response have been observed.

4. The method of claim 2, wherein administering a set of items from the plurality of items of the adaptive sign recognition test to a single individual when at least one correct and one incorrect response to the items have been observed, a finite maximum likelihood estimate of ability (bᵥ), as well as associated standard error sₑ, is computed; using the computed estimate of ability bᵥ, items that have not already been administered which have dᵢ closest to bᵥ are administered, with the further condition that the difference between the ability estimate and the selected item's difficulty is less than the standard error associated with the ability estimate; otherwise, testing is terminated with a message that items of appropriate difficulty have been exhausted.

5. The method of claim 4, wherein after each newly selected test item is presented and the individual's response is evaluated for correctness/incorrectness, the bᵥ is revised, making use of the additional information; the revised bᵥ is compared with the dᵢ of items remaining that have not already been administered so that items continue to be administered to the individual as long as the difference between their difficulty and each newly computed bᵥ remains within a decreasing standard error of measurement.

6. The method of claim 2, wherein testing is terminated when: (1) the remaining items are of inappropriate difficulty; (2) the individual has responded to L items; (3) the testing session reaches a time limit; or (4) the individual has been tested to a predetermined level of precision or reliability.

7. The method of claim 2, wherein item difficulty (dᵢ) and person ability (bᵥ) estimates are on the same numerical scale, facilitating the selection of items of appropriate difficulty to estimate the individual's ability level and the associated standard error immediately following the administration of each test item.

8. The method of claim 2, wherein the second group of individuals comprises one or more individuals.
